(19) United States
(12) Patent Application Publication
(10) Pub. No.: US 2016/0257430 A1
(43) Pub. Date: Sep. 8, 2016

(54) INTERNAL STRUCTURE VISUALIZATION METHOD AND AIRCRAFT REPAIR METHOD

(71) Applicant: MITSUBISHI AIRCRAFT CORPORATION, Aichi (JP)

(72) Inventors: Shotaro Hayashi, Tokyo (JP); Ryuichi Nagase, Tokyo (JP); Masayoshi Suhara, Tokyo (JP); Hiromu Okamoto, Tokyo (JP); Kiwamu Arikawa, Tokyo (JP); Morimasa Ishida, Aichi (JP)

(21) Appl. No.: 15/041,539

(22) Filed: Feb. 11, 2016

(30) Foreign Application Priority Data
Mar. 3, 2015 (JP) 2015-40818

(51) Int. Cl. B64F 5/00; G03B 21/00

(52) U.S. Cl. CPC B64F 5/0045; G03B 21/00

(57) ABSTRACT

An object of the present invention is to visualize an internal structural members, which are covered with a skin and therefore unrecognizable to the naked eye, from the outside of the skin. There is provided an internal structure visualization method applied to a main wing of an aircraft, which includes a skin with a front surface and a back surface and structural members supporting the skin from the back surface side, to display, when necessary, a trace map composed of lines extending along projection regions of the structural members, wherein functional lines, which are a developing element of the trace map, are provided along the projection regions of the front surface, and the trace map is displayed by performing a predetermined process on a predetermined region of the front surface where the functional lines are provided.

### BACKGROUND OF THE INVENTION

1. Field of the Invention

The present invention relates to a method for visualizing the arrangement of the internal structure of a structure which has load-bearing structural members provided on the inside.

2. Description of the Related Art

To ensure the safety of aircraft operation, various inspections are conducted while the aircraft is parked. Among these inspections is a visual inspection, in which damage caused in the airframe of the aircraft, e.g., in the wing, is detected, and repair is performed on the basis of the detection result. If a hole is left in the wing, work for closing this hole is performed using a repair member.

In this repair work, depending on the extent of damage, it is necessary to mount on the wing a jig for fixing the repair member to the wing, and this jig can reach inside the wing as shown in Japanese Patent Laid-Open No. 2014-188994 (FIG. 2), for example.

The wing includes a skin which is an outermost layer, and structural members, such as ribs and stringers, which are provided on the inside surrounded by the skin and resist loads applied to the wing. To maintain the soundness of these structural members, it is necessary to prevent the jig required for repair work from interfering with the structural members even when the jig penetrates the skin and reaches inside the wing. Conversely, it is also sometimes necessary to fix the jig using the internal structural members.

It is therefore an object of the present invention to provide a method for visualizing, from the outside, the internal structural members which are covered with the skin and therefore not visible to the naked eye.

### SUMMARY OF THE INVENTION

To achieve the above object, an internal structure visualization method of the present invention is a method applied to a structure, which includes a skin with a front surface and a back surface and structural members supporting the skin from the back surface side, to visualize, when necessary, a trace map composed of lines extending along projection regions of the structural members, wherein a developing element of the trace map is provided along the projection regions of the front surface, and the trace map is displayed by performing a predetermined process on a predetermined region of the front surface where the developing element is provided.

According to the present invention, when necessary, such as during repair, the trace map can be visualized and displayed simply by applying an external stimulus, such as heat or light, to a region including the location of damage. Thus, according to the present invention, interference between the fixing jig and the structural members can be precluded, or the fixing jig can be reliably mounted on the structural members, so that the burden of the repair work can be relieved.

In the visualization method of the present invention, as the developing element, a coating film can be used which is reversibly and repeatedly switched between its colored state and colorless state through application of an external stimulus as the predetermined process and removal of the external stimulus, and the trace map can be visualized on the front surface of the skin.

As such a coating film, a chromic paint can be used which loses its color when subjected to heat or light as the external stimulus and develops its color when the external stimulus is removed. In this case, if the coating film is provided so as to cover the trace map which is visibly drawn on the front surface of the skin, when the coating film develops its color, the trace map is masked thereby, and when the coating film loses its color, the trace map becomes visible there through.

As the coating film, an ultraviolet-reactive paint can also be used which becomes luminous when subjected to ultraviolet light as the external stimulus and loses its color when the ultraviolet light is removed. In this case, if the ultraviolet-reactive paint is provided as a coating film constituting the trace map on the front surface of the skin, when the coating film becomes luminous, the trace map is visualized, and when the coating film loses its color, the trace map disappears.

In the visualization method of the present invention, as the developing element, identification elements can also be used which are provided at a plurality of positions corresponding to the projection regions and each of which includes positional information specifying the position. A predetermined region including these identification elements is imaged as the predetermined process; the positions at which the plurality of identification elements included in the imaged predetermined region are provided are acquired; on the basis of the acquired positional information, image information constituting the trace map to be projected on the predetermined region is generated; and the trace map can be displayed on the basis of the generated image information.

In this visualization method, the trace map can be visualized on one or both of the front surface of the skin and a wearable device.

While the internal structure visualization method of the present invention can be used in arbitrary situations, the method can be applied when repairing a damaged portion of a skin. In this case, a region including the damaged portion of the skin is selected as the predetermined region of the front surface.

While the internal structure visualization method of the present invention can be applied to arbitrary objects, the object can be the airframe of an aircraft.

Thus, when repairing damage caused in the airframe of an aircraft which includes a skin with a front surface and a back surface and structural members supporting the skin from the back surface side, it is possible to perform the repair work with the trace map being displayed by one of the above-described internal structure visualization methods.

According to the present invention, it is possible to visualize and display the arrangement of internal structural members, which are covered with a skin and therefore not visible to the naked eye, as a trace map simply by applying an external stimulus such as heat or light. Thus, according to the present invention, interference between the fixing jig and the structural members can be precluded, or the fixing jig can be reliably mounted on the structural members, so that the burden of the repair work can be relieved.

### BRIEF DESCRIPTION OF THE DRAWINGS

FIG. 1 is a view showing a main wing of an aircraft, to which a first embodiment of the present invention is applied, with the dashed lines representing lines which extend along projection regions of structural members inside the wing;

FIG. 2 is a view showing the main wing of FIG. 1, with the dot-and-dash lines representing a functional paint applied to the surface of the wing along the structural members;

FIGS. 3A and 3B are views each showing the main wing of FIG. 1, in which FIG. 3A shows a state where the functional paint has lost its color, and FIG. 3B shows a state where the functional paint has partially developed its color and a trace map is visualized;

FIGS. 4A and 4B are views each showing a constitution example of a coating film of the functional paint, in which FIGS. 4A and 4B each show a cross-sectional view and a plan view on the upper side and the lower side, respectively;

FIGS. 5A and 5B are views each showing another constitution example of the coating film of the functional paint;

FIG. 6 is a view showing a main wing of an aircraft, to which a second embodiment of the present invention is applied, with the dashed lines representing structural members inside the wing and the outlined rectangles representing identification elements;

FIG. 7A is a view showing each identification element of FIG. 6 and positional information in correspondence with each other;

FIG. 7B is a view showing member-position correspondence information in which the structural members and the positional information correspond with each other;

FIG. 8A is a view showing a state where an area surrounding damage which requires repair is imaged in the second embodiment;

FIG. 8B is a state where a trace map is projected on the area surrounding the damage which requires repair in the second embodiment;

FIG. 9A is a flowchart showing a procedure in the second embodiment;

FIG. 9B is a view showing member-position correspondence information with check results; and

FIGS. 10A and 10B are views each showing a modified example of the second embodiment.

### DETAILED DESCRIPTION OF THE PREFERRED EMBODIMENTS

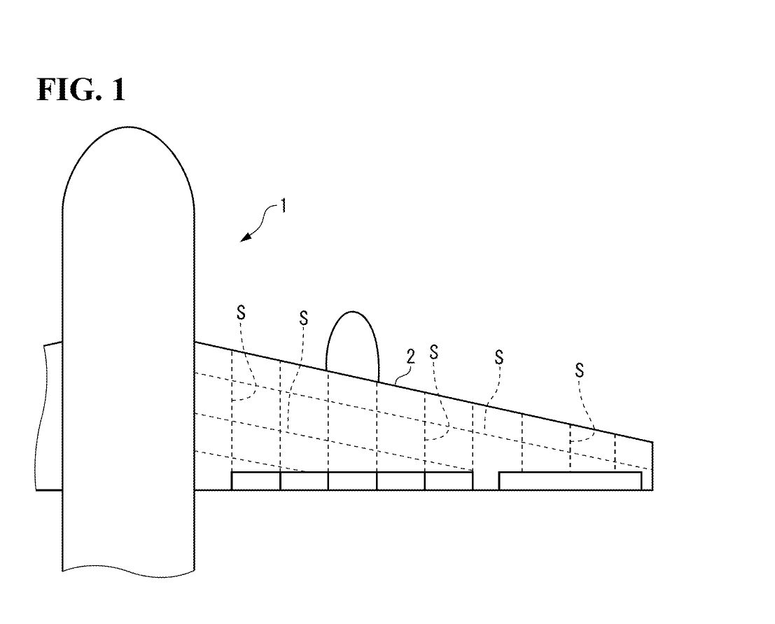

In the following, preferred embodiments of the present invention will be described using a main wing 2 of an aircraft 1 shown in FIG. 1 as an example.

The following embodiments include a first embodiment in which the arrangement of internal structural members S of the main wing 2 are drawn in advance on the surface of the main wing 2 using functional lines P, and a second embodiment in which identification information showing the arrangement of the internal structural members S of the main wing 2 is provided on the surface of the main wing 2.

### First Embodiment

The main wing 2 has the plurality of structural members S, which provide the main wing 2 with strength, provided on the inside at the positions indicated by the dashed lines in FIG. 1. The surface of the main wing 2 includes a skin, and when repairing damage in the skin, it is sometimes desired to recognize the positions of the structural members S. To respond to this desire, in the first embodiment, the functional lines P are used to visualize the positions, at which the structural members S are provided, on the surface of the main wing 2. When visualized, the functional lines P look like a map indicating the presence of the structural members S as lines, and these visualized lines will be referred to as a trace map in the present invention.

### Configuration of First Embodiment

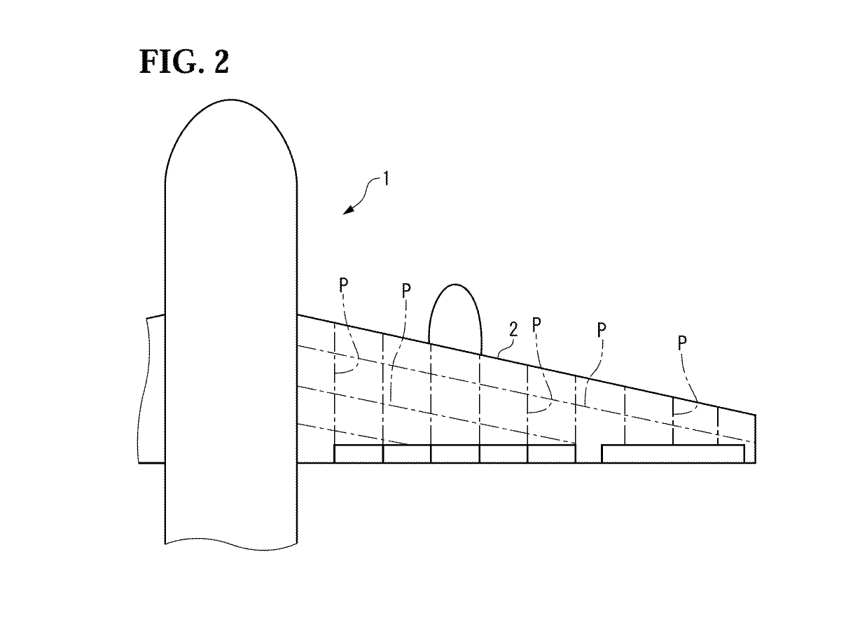

In this embodiment, as indicated by the dot-and-dash lines in FIG. 2, the functional lines P are drawn on the skin of the main wing 2 at the positions where the structural members S are provided, i.e., along the projection regions of the structural members S. When performing repair work, an external stimulus is applied to these functional lines P so as to develop its color (or lose its color) to thereby display the presence of the structural members S as the trace map on the skin of the main wing 2. On the other hand, except when damage is repaired, the functional lines P remain colorless (or colored), so that the trace map is not displayed. While the trace map can also be displayed at other times than during repair, as it would adversely affect the design of the aircraft 1, the trace map is not displayed except during repair.

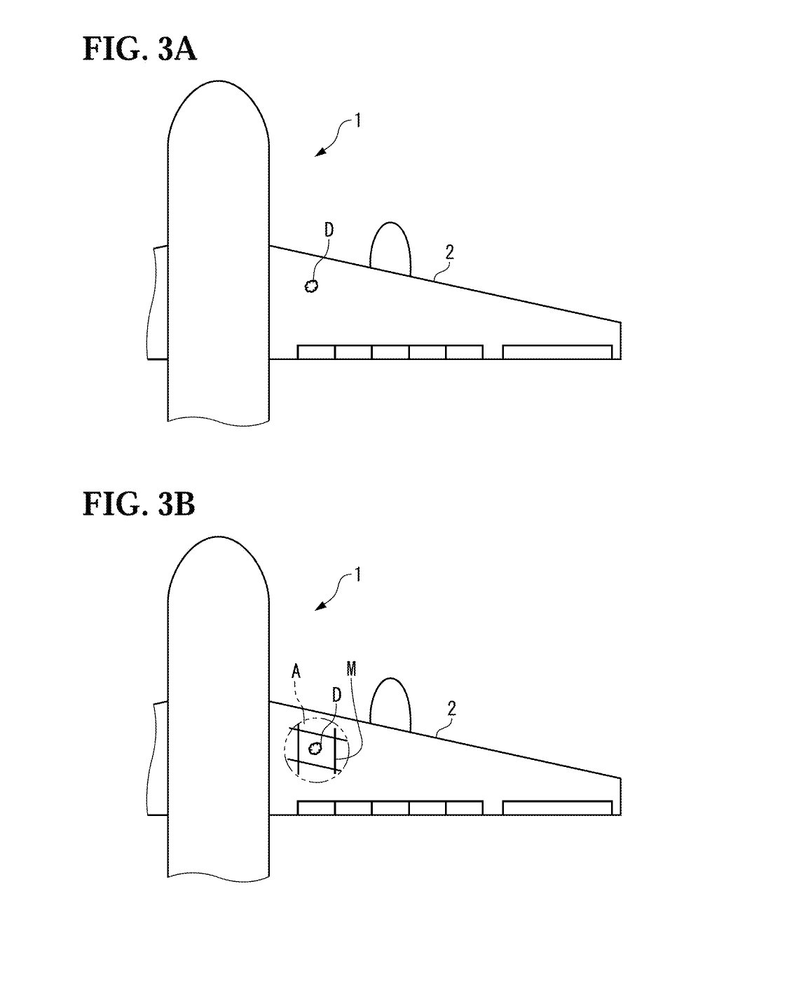

As shown in FIG. 3A, damage D caused in the skin of the main wing 2 will be repaired. As is described in Japanese Patent Laid-Open No. 2014-188994, this repair involves removing the damage D and the surrounding area and replacing the portion with a repair patch, and a jig is sometimes used to fix this repair patch. In the repair work, if the fixing jig interferes with the structural members S, the repair patch cannot be fixed. Conversely, it is sometimes necessary to mount the fixing jig on the structural members S to fix the patch. In this embodiment, therefore, the trace map based on the functional lines P is displayed on the main wing 2, for which it is sufficient to display a trace map M on a limited display region A around the damage D as indicated by the solid lines in FIG. 3B. Thus, it is sufficient to visualize the trace map M only in the area which is involved in interference of the fixing jig with the structural members S or mounting of the fixing jig to the structural members S.

In the present invention, the trace map M is displayed only on a certain display region A using the functional lines P which can be reversibly and repeatedly switched between its colored state and colorless state through application and removal of an external stimulus such as light or heat. Specifically, the trace map M is displayed on the display region A by applying an external stimulus, which is required for developing the color of the functional lines P, to the display region A. However, the trace map M may be displayed on an area outside the display region A.

Next, the specific configuration for displaying the trace map through application of an external stimulus to the functional lines P will be described.

First, an example will be described in which a paint having a thermochromism function (hereinafter, “thermochromic paint”) is used as the functional lines P, the thermoschromism function reversibly repeating the cycle of losing its color as an external thermal stimulus is applied thereto and developing its color as the external thermal stimulus is removed therefrom. The chromic molecules composing the chromic paint change in molecule structure under an external stimulus and change accordingly in absorption spectrum in the visible region, which allows the chromic paint to reversibly and repeatedly develop its color and lose its color. A paint which reversibly and repeatedly develops its color and loses its color when the external stimulus is heat is referred to as a thermochromic paint, and a paint which reversibly and repeatedly loses its color and develops its color when the external stimulus is light, especially ultraviolet light, is referred to as a photochromic paint.

To describe the thermochromic paint more specifically, for example, the thermochromic paint remains colored at 40° C. or lower, but when heated to 50° C. or higher, the paint loses its color and becomes transparent. Normally, a color developing temperature T1 is lower than a color losing temperature T2. The color developing temperature T1 of 40° C. and the color losing temperature T2 of 50° C. are mere examples, and some thermochromic paints on the market have the color developing temperature T1 and the color losing temperature T2 adjusted in increments of 5° C.

When the temperature of the aircraft 1 is compared between during flight and after landing, the temperature is lower during flight. Accordingly, if the thermochromic paint is used as is, the entire trace map M would be displayed during flight, while the trace map M would disappear during parking after landing. Therefore, in the case where a thermochromic paint is used to visualize the trace map M, it is desirable that the thermochromic paint itself does not display the trace map M, but instead the functional lines P function as a mask which obscures the trace map M during flight. Nevertheless, the present invention does not exclude the option of visualizing the trace map by developing the color of a thermochromic paint, which has been colorless, through application of cold energy having a temperature equal to or lower than the color developing temperature T1 as an external stimulus.

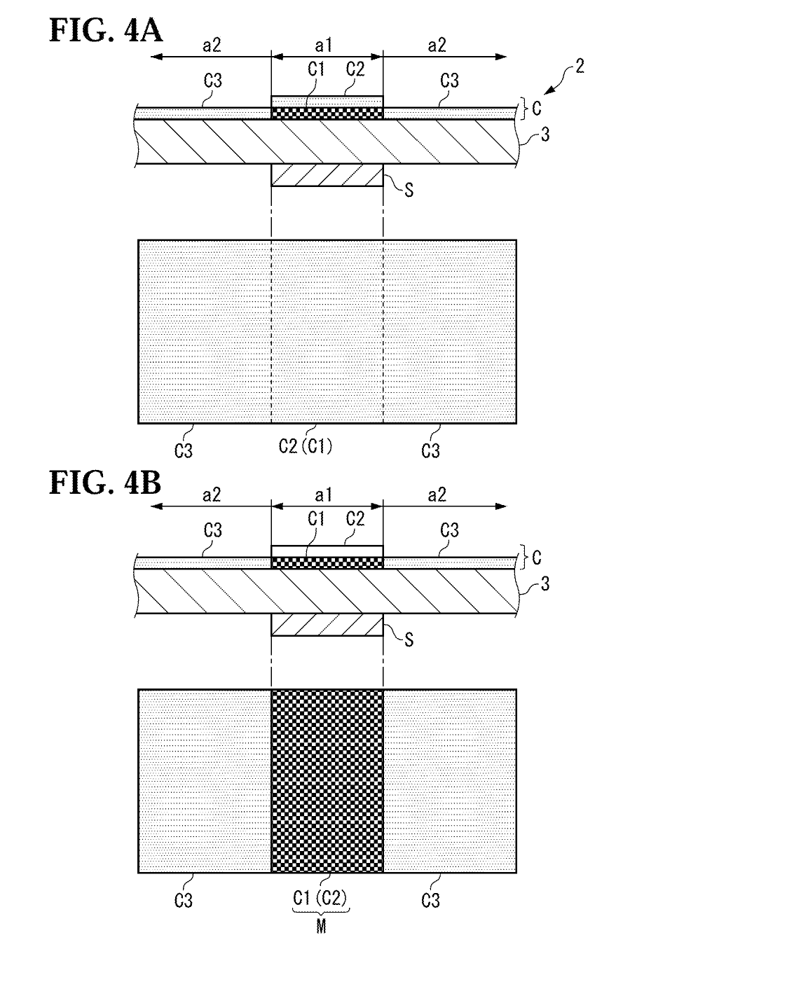

FIGS. 4A and 4B each show a cross-section of a portion and its vicinity where the skin 3 of the main wing 2 is supported on the structural member S, and the surface of the skin 3 is coated with a coating film C. The constitution of this coating film C is different between a projection region a1 of the structural member S and other region a2. That is, in the projection region a1, the coating film C is composed of two layers of the functional line P, a first lower coating film C1 provided on the skin 3 and a first upper coating film C2 provided on the first lower coating film C1, while in the region a2, the coating film C is composed of one layer, a second coating film C3 provided on the skin 3. The first upper coating film C2 of the projection region a1 and the second coating film C3 of the region a2 have the same color, for example, a yellow color, while the first lower coating film C1 of the projection region a1 has a blue color, for example, which is different from the first upper coating film C2 and the second coating film C3. The fill patterns of the first lower coating film C1, the first upper coating film C2, and the second coating film C3 in FIGS. 4A and 4B reflect their colors.

Here, the first upper coating film C2 and the second coating film C3 have the same color, but the paints used are different from each other: the first upper coating film C2 is a thermochromic paint, and the second coating film C3 is an ordinary paint. Here, an ordinary paint means a paint which does not change its color even when subjected to heat as an external stimulus. The first lower coating film C1 is an ordinary paint and has a different color from the second coating film C3. Accordingly, the first lower coating film C1 serves as the trace map M of the structural members S as will be described below.

FIG. 4A shows a state of the coating film C during flight, for example, when the aircraft 1 is in an environment at a temperature equal to or lower than the color developing temperature T1. The first upper coating film C2 of a thermochromic paint has developed a yellow color as an example, and since the first upper coating film C2 is indistinguishable from the second coating film C3 in terms of color, the skin 3 as a whole assumes a yellow color. Since the first lower coating film C1 is masked by the yellow first upper coating film C2, the trace map M is not visualized on the surface of the main wing 2.

FIG. 4B shows a state of the coating film C when the above-mentioned display region A is heated for repairing the damage D (FIGS. 3A and 3B). This heating is to apply an external stimulus which is required for the skin 3 of the display region A to rise in temperature to or above the color losing temperature T2 of the thermochromic paint, and this heating causes the first upper coating film C2 to lose its color and become transparent (shown as an outline). As a result, the first lower coating film C1, which is a layer under the first upper coating film C2, is released from the mask, so that the blue trace map M is displayed. A warm-air heater, a planar heater, etc. can be used to heat the display region A.

In FIGS. 4A and 4B, the first upper coating film C2 of a thermochromic paint is provided only in the projection region a1. However, in the case where the thermochromic paint is used so as to lose its color by being warmed, the paint may also be applied to the region a2, for example, even to the entire surface.

Using this trace map M as a guide, a repair worker can perform the work so as to avoid interference between the fixing jig and the structural members S, or can correctly mount the fixing jig on the structural members S.

In the example shown in FIGS. 4A and 4B, the trace map can be similarly displayed when a photochromic paint, instead of the thermochromic paint, is used for the first upper coating film C2. That is, when subjected to sunlight, a photochromic paint, which has been colorless, can develop a yellow color, a blue color, etc. under the stimulus of ultraviolet light, and loses its color and becomes transparent when the sunlight is blocked. Accordingly, in the above example, if a photochromic paint which develops a yellow color is used for the first upper coating film C2, during flight, the first upper coating film C2 masks the blue color of the first lower coating film C1. On the other hand, if the aircraft 1 is housed in a building where sunlight can be blocked during repair, as the first upper coating layer C2 of a photochromic paint loses its color, the trace map of the blue first lower coating film C1 can be displayed and visualized on the surface of the main wing 2.

In the foregoing description, the example in which the trace map is displayed using a chromic paint is shown, but a luminous body which becomes luminous in response to ultraviolet light can also be used as the paint.

An ultraviolet-reactive body is a substance which becomes luminous when subjected to excitation light of near-ultraviolet light having a wavelength of 350 to 400 nm as an external stimulus, and typically the ultraviolet-reactive body becomes luminous blue, yellow, etc. when irradiated with black light. The ultraviolet-reactive body becomes colorless and transparent when ultraviolet light irradiation is stopped. If ultraviolet light is used as an external stimulus, the ultraviolet-reactive body can be used as the functional line P which can be reversibly and repeatedly switched between its luminous state, in which the color is developed, and its colorless state.

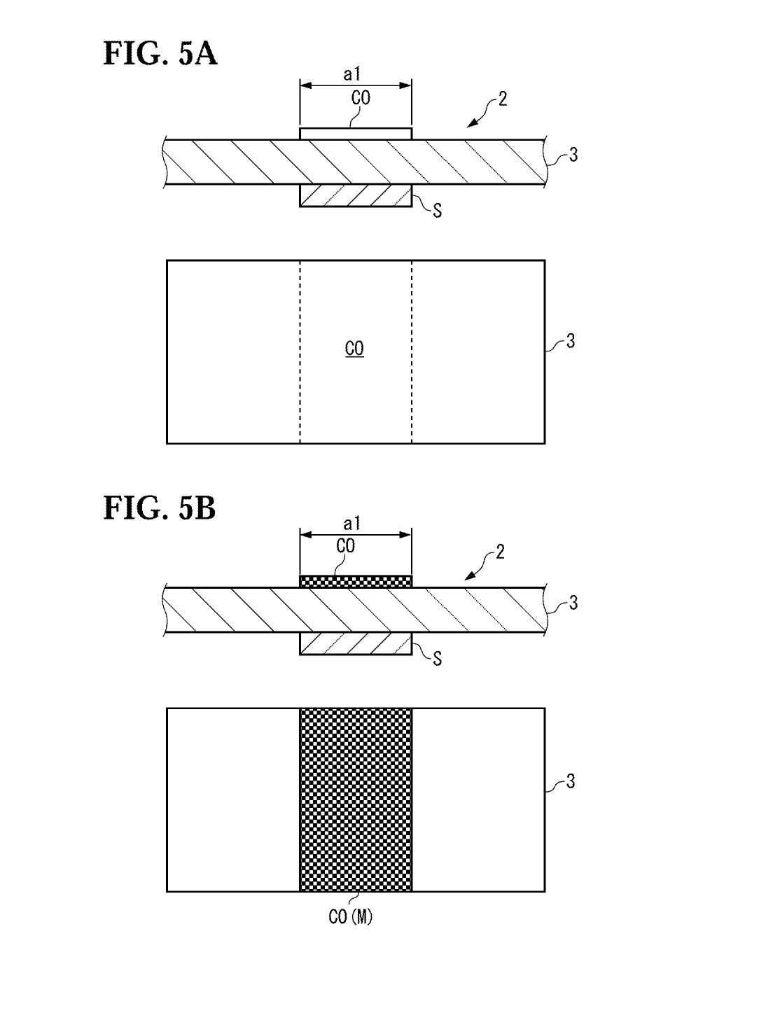

Since this ultraviolet-reactive paint is an originally colorless transparent paint which develops its color by being irradiated with ultraviolet light, the ultraviolet-reactive paint is not used as a mask like a chromic paint, but instead, as shown in FIG. 5A, only a first coating film C0 of the ultraviolet-reactive paint is provided in the projection region a1 where the trace map is to be displayed. While this first coating film C0 remains colorless and transparent at normal times, when irradiated with near-ultraviolet light using black light during repair of the damage D, the first coating film C0 develops its color as shown in FIG. 5B, so that the trace map can be visualized.

### Effects of First Embodiment

As has been described above, in the first embodiment, a paint which is reversibly and repeatedly switched between its colored state and colorless state through application of an external stimulus is provided as the developing element of the trace map on the main wing 2. Therefore, at the time of repair, the trace map can be displayed on the surface of the main wing 2 simply by applying an external stimulus (heat, light) to the display region A including the location of the damage D. Thus, according to this embodiment, interference between the fixing jig and the structural members S can be precluded, or the fixing jig can be reliably mounted on the structural members S, so that the burden of the repair work can be relieved.

Moreover, what is required as the external stimulus is heat or light, and the external stimulus is applied to only a limited area. Thus, the first embodiment can be implemented at any place with simple equipment.

### Second Embodiment

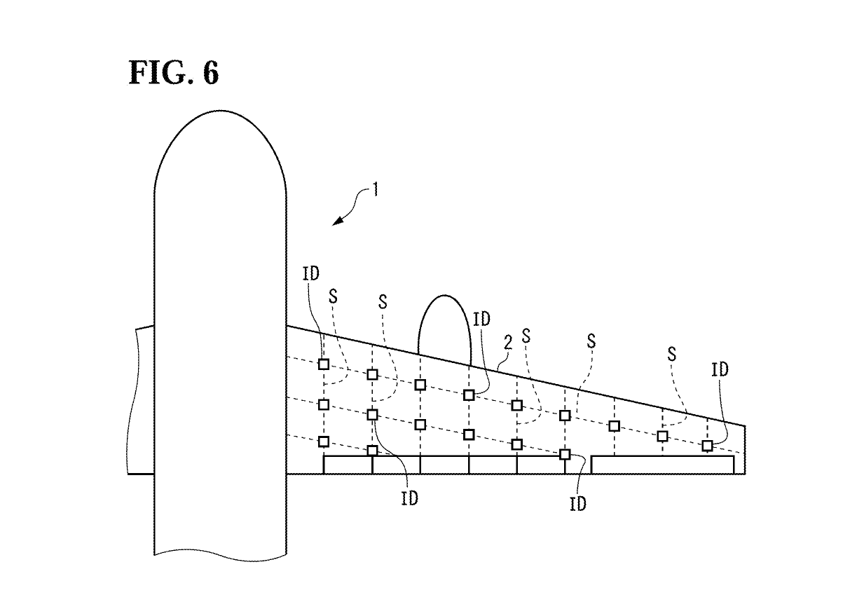

Next, the second embodiment of the present invention will be described with reference to FIG. 6 to FIG. 10B. For the same components as in the first embodiment, the same reference signs as in the first embodiment are given in FIG. 6 to FIG. 10B.

In the second embodiment, as the element which displays the trace map, identification elements ID which include information specifying the positions of intersection points of the projection regions of the structural members S are arranged at the intersection points on the surface of the main wing 2 as shown in FIG. 6. As the identification element ID, a two-dimensional code represented by a barcode, or a three-dimensional code represented by a QR code (R) can be used. However, these are not the only options, and as long as the position of each identification element ID can be specified, the surface shape of the main wing 2 (the wing shape, protrusions, wing joints, etc.) can also be used as the identification element ID.

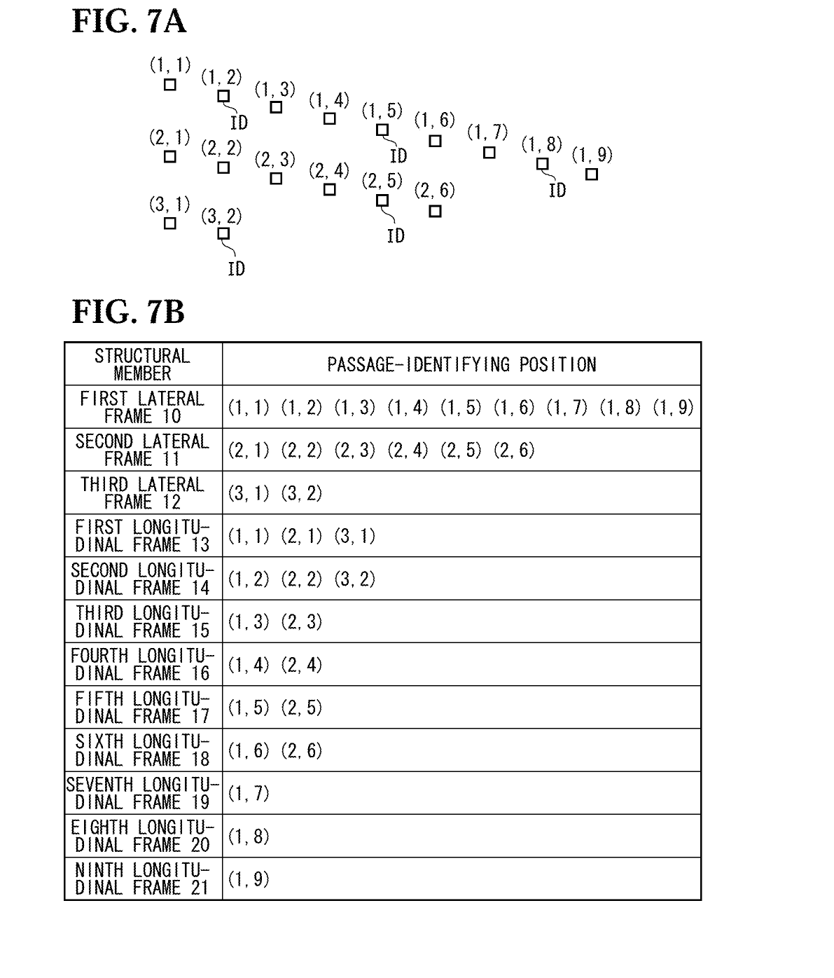

As shown in FIG. 7A, the identification elements ID are each assigned a two-dimensional coordinate, (1, 1), (1, 2) . . . (3, 2), as the information specifying their positions.

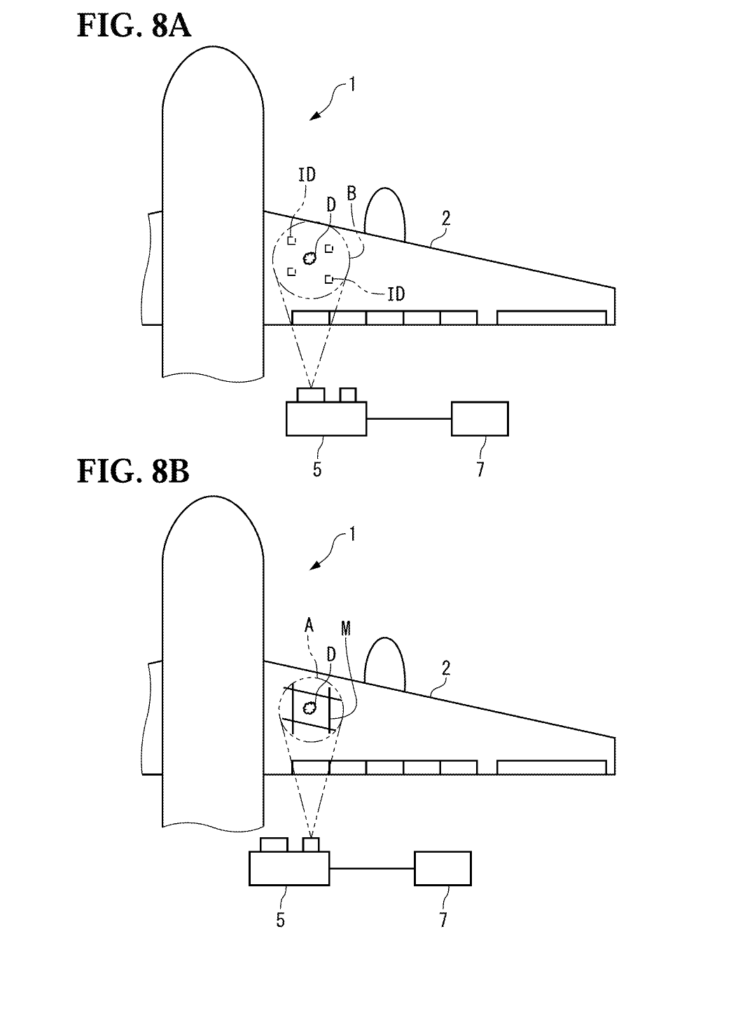

As shown in FIGS. 8A and 8B, the second embodiment employs an optical apparatus 5. This optical apparatus 5 has two functions, an imaging function of acquiring an image of the surface of the main wing 2 and a projection function of projecting the trace map on the surface of the main wing 2. Thus, the optical apparatus 5 can be regarded as a camera and a projector provided in one casing.

The operation of the optical apparatus 5 is controlled by a controller 7 which is a personal computer, for example. In addition to controlling the operation of the optical apparatus 5, the controller 7 analyzes the surface image of the main wing 2 acquired by the imaging function of the optical apparatus 5, and acquires positional information of each identification element ID shown in the image. On the basis of the acquired positional information of the identification elements ID, the controller 7 generates image information constituting the trace map to be projected on the surface of the main wing 2, and moreover commands the optical apparatus 5 to project this trace map based on the image information on the surface of the main wing 2.

To generate the image information constituting the trace map to be projected, the controller 7 retains member-position correspondence information shown in FIG. 7B, for example, in which the structural members and the positional information correspond with each other. While this member-position correspondence information can be included as part of design data for the aircraft 1 including the main wing 2, to simplify the description, the member-position correspondence information is shown here as minimum necessary information.

The member-position correspondence information of FIG. 7B is information in which the structural members S are respectively named a first lateral frame 10 to a third lateral frame 12 and a first longitudinal frame 13 to a ninth longitudinal frame 21, and each frame corresponds to intersection points (two-dimensional coordinates) which the frame passes through. For example, it is specified that the first lateral frame 10 passes through the intersection points (1, 1) . . . (1, 9) and the first longitudinal frame 13 passes through the intersection points (1, 1) . . . (3, 1).

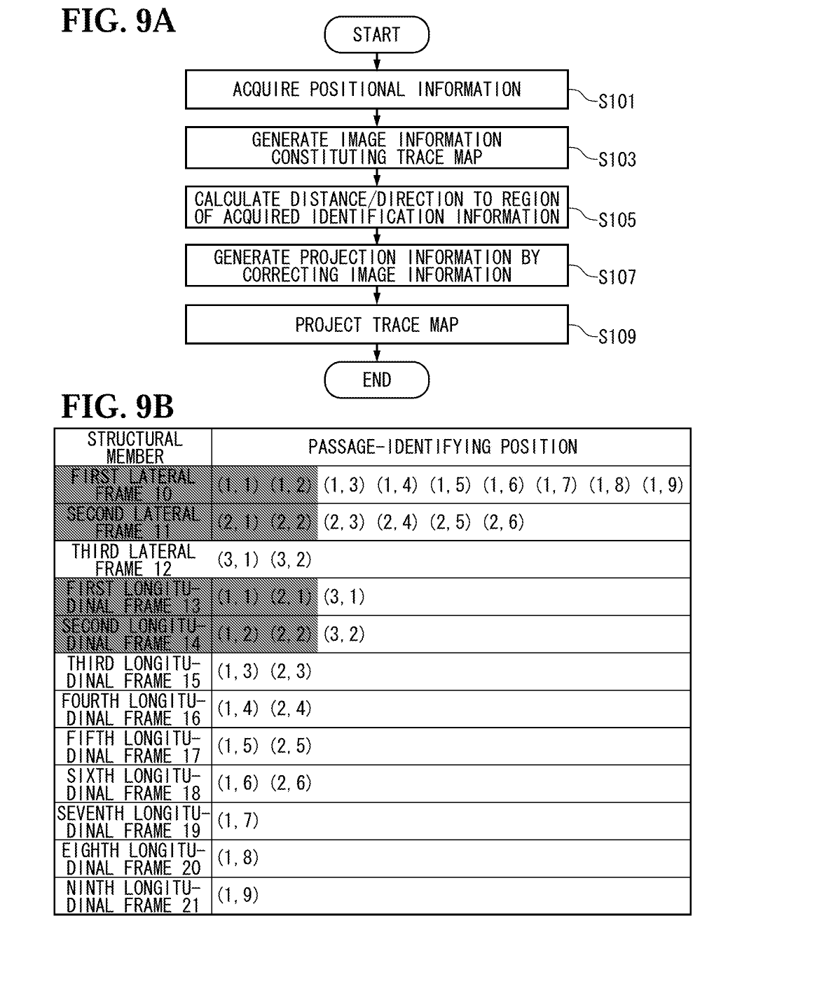

Next, a procedure for displaying the trace map on the main wing 2 provided with the identification elements ID will be described with reference to FIGS. 8A, 8B and FIGS. 9A and 9B.

First, as shown in FIG. 8A, the area surrounding the damage D is imaged using the imaging function of the optical apparatus 5. Since the identification elements ID are included in an imaging region B (to be the display region A) indicated by the two-dot chain lines, the controller 7 acquires imaging information on the imaging region B and interprets the identification elements ID included in this region to acquire the positional information of each identification element ID (S101 of FIG. 9A).

Next, in the case of the example shown in FIG. 8A, since the identification elements ID corresponding to the positional coordinates (1, 1), (1, 2), (2, 1), and (2, 2) are included, the controller 7 checks the acquired positional information and the member-position correspondence information it retains against each other. Here, the check results are shown in FIG. 9B with hatching. As a result of the check, the first lateral frame 10, the second lateral frame 11, the first longitudinal frame 13, and the second longitudinal frame 14 are extracted, and the controller 7 generates image information which constitutes a trace map corresponding to these extraction results (frames) (S103 of FIG. 9A). However, the controller 7 does not generate image information which constitutes a trace map corresponding to the full lengths of these frames, but generates image information which constitutes a trace map within an area surrounded by the coordinate positions indicated by (1, 1), (1, 2), (2, 1), and (2, 2), or within an area allowing for some margin to that area.

Here, the identification elements ID are located near the intersection points between the longitudinal and lateral frames, but this is not the only possibility, and it is also acceptable that the identification elements ID are present at positions irrelevant to and different from the positions of the frames, as long as the image information constituting a trace map is related to the identification elements ID.

Next, the controller 7 calculates the distance and direction to the imaged surface of the main wing 2 from the size of each of the plurality of identification elements ID included in the imaging information and the positional relation among these identification elements ID (S105 of FIG. 9A), and generates projection information by correcting the image information constituting the trace map while, as necessary, taking into account three-dimensional information about the surface of the main wing 2 included in the design data (S107 of FIG. 9A).

The controller 7 commands the optical apparatus 5 to project the trace map on the main wing 2 on the basis of the generated projection information. Then, upon receiving this command, the optical apparatus 5 projects and visualizes the trace map M on the surface of the main wing 2 as shown in FIG. 8B (S109 of FIG. 9A).

As has been described above, in the second embodiment, the identification elements ID are provided as the developing element of the trace map on the main wing 2. Therefore, at the time of repair, the trace map can be displayed on the surface of the main wing 2 simply by imaging the display region A including the location of the damage D. Thus, according to this embodiment, interference between the fixing jig and the structural members S can be precluded, or the fixing jig can be reliably mounted on the structural members S, so that the burden of repair work can be relieved.

Since the imaging area and the projection area are not the entire main wing 2 but are limited to only a part of the main wing 2, only the simple optical apparatus 5 needs to be prepared.

While the present invention has been described on the basis of the preferred embodiments, it is possible to selectively adopt the configurations presented in the above embodiments or appropriately modify these configurations into other configurations within the scope of the present invention.

In the first embodiment, visualization of a trace map may be continuously or intermittently performed along the structural members S. The interval in the case of intermittent visualization is desirably shorter than the interval of the intersection points shown in the second embodiment.

In the first embodiment, the width of the structural member S and the width of the first lower coating film C1 and the first upper coating film C2 are equal as shown in FIGS. 4A, 4B and FIGS. 5A, 5B. However, the present invention is not limited to this example, and even when these widths are not equal, the coating film can function as a trace map.

In the second embodiment, it is possible to display locations of past repair in the trace map by including information, which indicates previous repair of the damage D, in the projection information. If it is known that there is a location of past repair near the damage D which is to be repaired, repair of the damage D can be properly performed in consideration of the location of past repair. To realize this, the controller 7 retains the positional coordinates of the locations of past repair which are on the same coordinates as the positional coordinates assigned to the identification elements ID, and checks the positional coordinates corresponding to the locations of past repair against the image information constituting the trace map to find whether or not any positional coordinate corresponding to the locations of past repair is included in the area of the positional coordinates specifying the image information. Then, if any positional coordinate corresponding to the locations of past repair is included, the locations of past repair can be projected on the main wing 2 along with the trace map by including this positional coordinate in the image information constituting the trace map. Moreover, at the time of inspection, damaged portions on record can be visualized so that those portions which are to be intensively inspected are not overlooked.

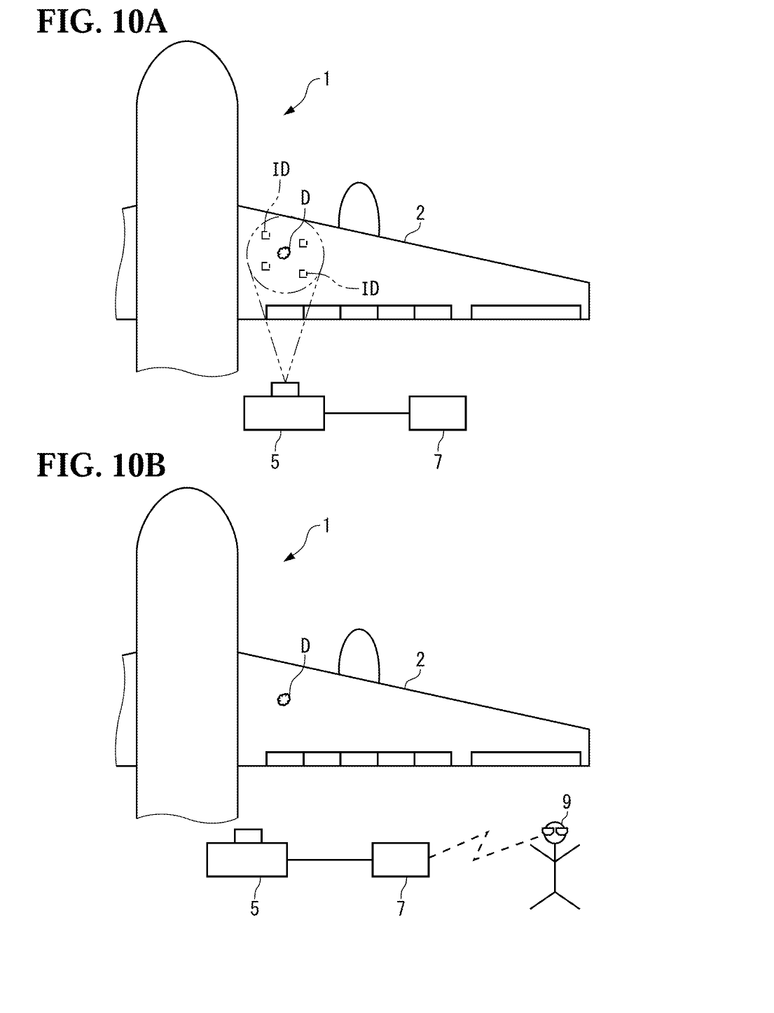

In the second embodiment, the trace map is projected on the main wing 2, but the present invention is not limited to this example. For example, as shown in FIGS. 10A and 10B, the trace map can be displayed on a wearable device 9 worn by a repair worker W. That is, the optical apparatus (which is a camera here) 5 and the glasses-type wearable device 9 are combined so that the internal structure of the wing becomes visible through the wearable device 9. The position of the wearable device 9 is acquired by imaging the wearable device 9 through wireless communication or with a camera. Alternatively, the wearable device 9 may have a structure integrating a camera and glasses to save the trouble of acquiring information on the position of the wearable device 9.

The above embodiments have been described using the main wing 2 of the aircraft 1 as the object, but the present invention is not limited to this example and can also be applied to structural parts of the aircraft 1 other than the main wing 2, or to structures other than the aircraft 1 as well.

What is claimed is:

1. An internal structure visualization method applied to a structure, which includes a skin with a front surface and a back surface and structural members supporting the skin from the back surface side, to visualize, when necessary, a trace map composed of lines extending along projection regions of the structural members, wherein
a developing element of the trace map is provided along the projection regions of the front surface, and
the trace map is displayed by performing a predetermined process on a predetermined region of the front surface where the developing element is provided.

2. The internal structure visualization method according to claim 1, wherein
the developing element is a coating film which is reversibly and repeatedly switched between its colored state and colorless state through application of an external stimulus as the predetermined process and removal of the external stimulus, and
the trace map is visualized on the front surface of the skin.

3. The internal structure visualization method according to claim 2, wherein
the coating film is a chromic paint which loses its color when subjected to heat as the external stimulus and develops its color when the external stimulus is removed,
the coating film is provided so as to cover the trace map which is visibly drawn on the front surface of the skin, and
when the coating film develops its color, the trace map is masked thereby, and when the coating film loses its color, the trace map is visualized therethrough.

4. The internal structure visualization method according to claim 2, wherein
the coating film is an ultraviolet-reactive paint which becomes luminous when subjected to ultraviolet light as the external stimulus and loses its color when the ultraviolet light is removed,
the ultraviolet-reactive paint is provided as a coating film constituting a trace map on the front surface of the skin, and
when the coating film develops its color, the trace map becomes luminous, and when the coating film loses its color, the trace map disappears.

5. The internal structure visualization method according to claim 1, wherein
the developing element is identification elements which are provided at a plurality of positions corresponding to the projection regions and each of which includes positional information specifying the position,
a predetermined region including the identification elements is imaged as the predetermined process, and the positions at which the plurality of identification elements included in the imaged predetermined region are provided are acquired,
on the basis of the acquired positional information, image information constituting the trace map to be projected on the predetermined region is generated, and
the trace map is displayed on the basis of the generated image information.

6. The internal structure visualization method according to claim 5, wherein the trace map is displayed on one or both of the front surface of the skin and a wearable device.

7. The internal structure visualization method according to claim 1, wherein the predetermined region of the front surface includes a damaged portion of the skin.

8. The internal structure visualization method according to claim 1, wherein the structural members constitute a part of the airframe of an aircraft.

9. An aircraft repair method for repairing damage caused in the airframe of an aircraft which includes a skin with a front surface and a back surface and structural members supporting the skin from the back surface side, wherein repair work is performed with the trace map being displayed by the internal structure visualization method according to claim 1.
